(19) United States
(12) Patent Application Publication
(10) Pub. No.: US 2009/0106936 A1
(43) Pub. Date: Apr. 30, 2009

(54) Pillar Mounted Vehicle Hinge

(76) Inventor: Dan Greenbank, San Diego, CA (US)

Correspondence Address: MARC E. HANKIN, ESQ., 11414 THURSTON CIRCLE, LOS ANGELES, CA, 90049, US

(21) Appl. No.: 12/262,113

(22) Filed: Oct. 30, 2008

Related U.S. Application Data
(60) Provisional application No. 60/983,926, filed on Oct. 30, 2007.

(51) Int. Cl. E05D 7/00

(52) U.S. Cl. 16/223; 16/250

(57) ABSTRACT

Various embodiments of this invention disclose a vehicle door hinge that combines: aerodynamic features; a pleasing aesthetic shape; a hinge axis between the door and the A-pillar of the vehicle; an inexpensive price; off-the-shelf availability; and an ability to open a door simultaneously outward and upward.

### CROSS-REFERENCE TO RELATED APPLICATIONS

Priority is claimed to U.S. Provisional Patent Application Ser. No. 60/983,926, filed on Oct. 30, 2007, and titled “A-Pillar Mounted Automotive Hinge.” This priority application is incorporated by reference herein as though set forth herein in full.

### BACKGROUND OF THE INVENTION

This invention generally relates to hinge devices. Specifically, it pertains to a vehicle door hinge that is mounted to the base of the A-pillar of a vehicle and causes a vehicle door to open simultaneously in an outward and upward manner. This type of vehicle door hinge is called a gull-wing hinge.

Vehicle door hinges are typically heavy-duty utilitarian hinges that allow the vehicle driver and passengers to enter or exit the vehicle in a routine manner. Vehicle doors are usually attached to the vehicle at the front edge of the vehicle door, and they swing outward from vehicle within a very limited horizontal range. Additionally, many vehicle doors are attached to the vehicle frame at two hinge connection points, which severely limits the doors range of motion.

Currently no vehicle door hinge is available that has: aerodynamic features; a pleasing aesthetic shape; hinging between the door and the A-pillar of the vehicle; a robust design despite a compact size; and an ability to open a door simultaneously outward and upward. Additionally, no vehicle door hinge is specifically designed to bear the weight of the vehicle door while pivoting from a singe point at the base of the A-pillar of the vehicle.

Thus, there remains a long felt need in the art for a vehicle door hinge that combines: aerodynamic features; a pleasing aesthetic shape; a hinge axis between the door and the A-pillar of the vehicle; an inexpensive price; off-the-shelf availability; and an ability to open a door simultaneously outward and upward.

### BRIEF SUMMARY OF THE INVENTION

To minimize the limitations in the prior art, and to minimize other limitations that will become apparent upon reading and understanding the present specification, the present invention discloses a vehicle door hinge that combines: aerodynamic features; a pleasing aesthetic shape; a hinge axis between the door and the A-pillar of the vehicle; an inexpensive price; off-the-shelf availability; and an ability to open a door simultaneously outward and upward.

One embodiment of this invention is a vehicle door hinge, comprising: a mounting base plate; an A-pillar hinge housing; a hinge pin; a hinge top leaf; a door reinforcement plate; a lift support; a chassis angle mount; a door angle mount; and one or more washers. The mounting base plate is attached to an A-pillar of a vehicle. The door reinforcement plate is attached to a vehicle door reinforcement structure. The hinge top leaf comprises a top leaf body and one or more top leaf hinge knuckles. The A-pillar hinge housing comprises an A-pillar hinge body and one or more A-pillar hinge housing knuckles. The hinge pin connects the one or more A-pillar hinge housing knuckles and the one or more top leaf hinge knuckles at a hinge pivot axis. The A-pillar hinge housing is attached to the mounting base plate. The hinge top leaf is attached to the door reinforcement plate. The hinge pivot axis is positioned just above a vehicle door so that when the vehicle door is opened a door skin clears a fender skin. The chassis angle mount is mounted to a chassis of the vehicle. The door angle mount is mounted to the vehicle door. The lift support comprises a chassis end and a door end. The lift support chassis end connects to the chassis angle mount and the lift support door end connects to the door angle mount. The lift support provides support in lifting the vehicle door when opening or closing the vehicle door. The door reinforcement structure is a side impact beam of the vehicle door. The A-pillar of the vehicle is a roll over reinforcement structure of the vehicle. The hinge top leaf has an aerodynamic shape that reduces wind resistance. The one or more washers are placed between the one or more A-pillar hinge housing knuckles and the one or more top leaf hinge knuckles such that a precise paint gap is maintained. The one or more A-pillar hinge housing knuckles have threaded end caps that secure the hinge pin. The mounting base plate has one or more chamfered surfaces that facilitate attachment to the A-pillar. The mounting base plate further comprises threaded holes that facilitate attachment to the A-pillar hinge housing.

An object of the present invention is to provide a vehicle door that will overcome the deficiencies of the prior art.

Another object of the present invention is to provide a vehicle door hinge that allows the user to open the door simultaneously upward and outward.

Another object of the present invention is to provide a vehicle door hinge that is inexpensive, compact, and compatible with most vehicle doors.

Another object of the present invention is to provide a vehicle door hinge that is safe and easy to use, and allows for safe and easy entrance and exit from the vehicle.

Another object of the present invention is to provide a durable vehicle door hinge that may be used by a wide variety of people regardless of their body size or strength.

Another object of the present invention is to provide a compact inexpensive, easy to install, and off-the-shelf vehicle door hinge that can be installed on a vehicle door to convert the door into a gull wing type door.

Another object of the invention is to provide a vehicle door hinge a vehicle door hinge that combines: aerodynamic features; a pleasing aesthetic shape; a hinge axis between the door and the A-pillar of the vehicle; an inexpensive price; off-the-shelf availability; and an ability to open a door simultaneously outward and upward.

Other features and advantages are inherent in the vehicle door hinge claimed and disclosed will become apparent to those skilled in the art from the following detailed description and its accompanying drawings.

### BRIEF DESCRIPTION OF THE DRAWINGS

FIG. 1 is an illustration of a perspective view of one embodiment of the vehicle hinge in a closed position.

FIG. 2 is an illustration of an exploded view of one embodiment of the vehicle hinge.

FIG. 3 is an illustration of a perspective view of one embodiment of a ball joint.

FIG. 3 is an illustration of a perspective view of one embodiment of a door angle mount for a ball joint.

FIG. 5 is an illustration of a perspective view of one embodiment of a chassis angle mount for a ball joint.

FIG. 6 is an illustration of an inside view of a vehicle with one embodiment of the vehicle hinge that is in an open position.

FIG. 7 is an illustration of an outside view of a vehicle with one embodiment of the vehicle hinge that is in an open position.

### DETAILED DESCRIPTIONS OF THE DRAWINGS

In the following detailed description of the preferred embodiment, reference is made to the accompanying drawings that form a part hereof, and in which is shown, by way of illustration, a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance “lift support” refers to any device that can aid a person in moving a vehicle door in an upward or vertical direction. A “lift support” is preferably a cylindrical gas spring, known in the art of vehicle doors, but it can be a mechanical spring, a pump, a motorized linear actuator, hydraulic cylinder, an air cylinder, or a pneumatic pump. Further, a lift support may be any shape without deviating from the scope of the present invention. An “A-pillar” refers to the shaft of material that supports the windshield (windscreen) of a car on either of the windshield frame sides. Preferably an A-pillar is also a roll over reinforced beam. “Skin” refers to the visible outer shell of the vehicle or vehicle part. “Chamfered surfaces” refers to a surface that has been beveled, angled, or sloped to allow easier fitting or connection to another surface. Typically chamfered surfaces refers to a forty-five (45) degree straight beveled edge, but it can refer to any shape or slope given to a beveled surface.

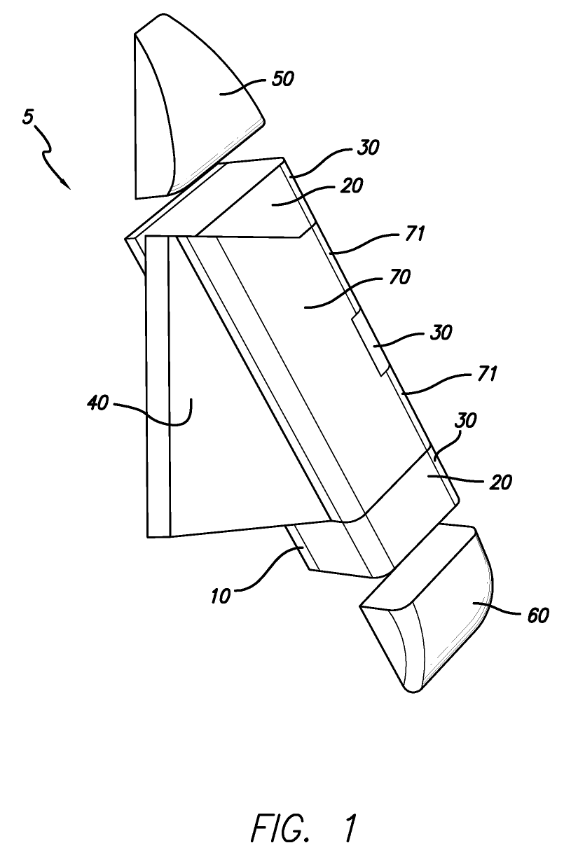

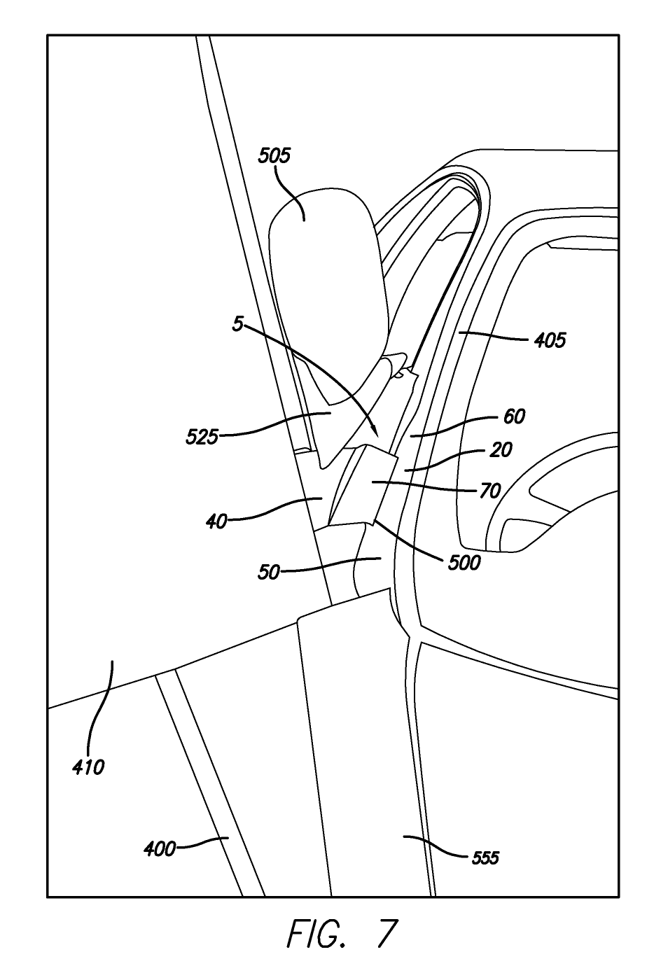

FIG. 1 is an illustration of a perspective view of one embodiment of the vehicle hinge in a closed position. As shown in FIG. 1, vehicle hinge 5 preferably comprises: a mounting base plate 10; an A-pillar hinge housing 20; A-pillar hinge housing knuckles 30; a door reinforcement plate 40; aerodynamic structures 50 and 60; hinge top leaf 70; and top leaf hinge knuckles 71. FIG. 1 shows the preferred fitting of the parts of vehicle hinge 5 when the hinge is in a closed position. FIG. 1 shows how A-pillar hinge housing 20 is attached to the top of mounting base plate 10. Top leaf hinge knuckles 71, as shown in FIG. 1, are an extension of, or attached to, hinge top leaf 70. Door reinforcement plate 40 is sandwiched between A-pillar hinge housing 20 and hinge top leaf 70. Preferably, as shown in FIG. 1, there are two top leaf hinge knuckles 71 and they are fitted to the three A-pillar hinge housing knuckles 30. The top leaf hinge knuckles 71 and the A-pillar hinge housing knuckles 30 are connected with a hinge pin (unseen in FIG. 1). The connection of these two sets of knuckles forms the hinge pivot axis (as shown in FIG. 7).

FIG. 1 also shows how hinge top leaf 70 is preferably rounded for a streamlined look and aerodynamic shape. Aerodynamic structures 50 and 60, as shown in FIG. 1, further enhance the aerodynamic shape of the hinge by providing a rounded slope before and after the main body of the hinge. The aerodynamic features of vehicle hinge 5 aid in the reduction of wind resistance and noise when the vehicle is moving.

Although FIG. 1 shows each of the parts of vehicle hinge 5 have a particular geometric shape, they can be any shape so long as the parts fluidly fit together in a flush mount fashion.

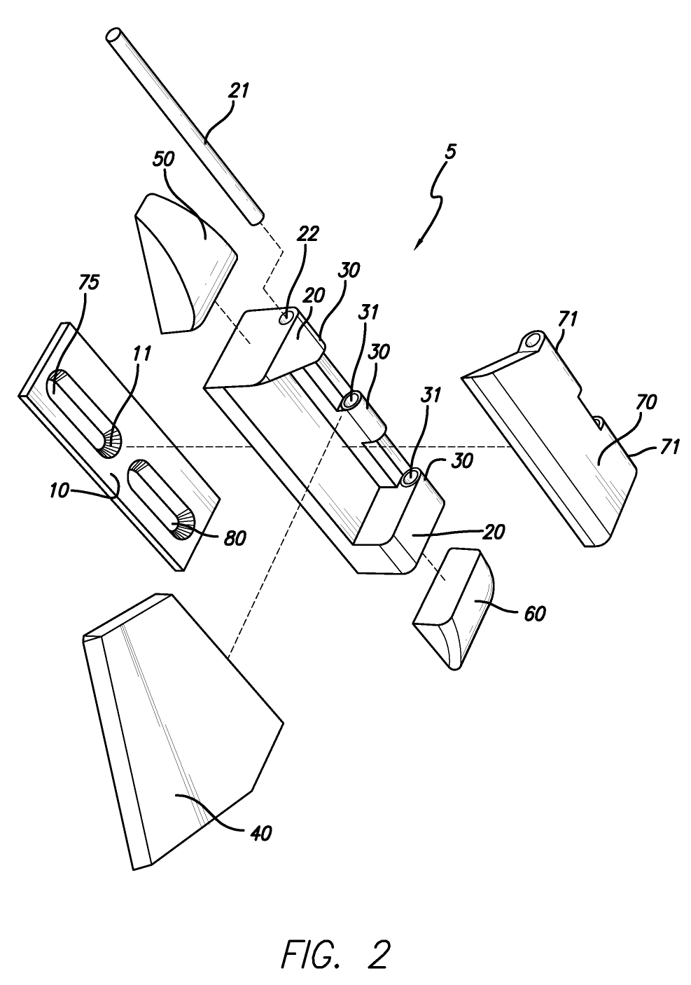

FIG. 2 is an illustration of an exploded view of one embodiment of the vehicle hinge. As shown in FIG. 2, vehicle hinge 5 preferably includes a mounting base plate 10, chamfered surface 11, an A-pillar hinge housing 20, hinge pin 21, threaded hinge pin fastener 22, A-pillar hinge housing knuckles 30, a door reinforcement plate 40, aerodynamic structures 50 and 60, hinge top leaf 70, top leaf hinge knuckles 71, flush mount holes 75 and 80. Hinge pin 20 passes through A-pillar hinge housing knuckles 30 and top leaf hinge knuckles 71 to form the axis of the hinge. Hinge pin 20 is secured into A-pillar hinge housing at threaded hinge pin fastener 22.

Although not shown, door reinforcement plate 40 may also have a chamfered surface.

FIG. 2 shows that each of the parts of vehicle hinge 5 is robust and will be able to withstand the weight of a vehicle door as it opens simultaneously in an upward and outward manner. Door reinforcement plate 40, as preferred, extends deep within A-pillar hinge housing 20, and extends distally away from A-pillar hinge housing 20 with a robust, triangular shape. This allows door reinforcement plate 40 to be securely attached to an attachment means, such as a steel plate, which is then directly connected to a reinforced structure (along with other primarily cosmetic structures) in a vehicle door. This allows vehicle hinge 5 to bear the weight of the door in an open position.

FIG. 2 shows mounting base plate 10, as preferred, with two flush mount holes 75 and 80. These holes facilitate more complete welding of mounting base plate 10 to the A-pillar of the vehicle. There can be any number of holes or no holes without deviating from the scope of this invention. FIG. 2 also shows mounting base plate 10 with the preferred chamfered surface. This allows mounting base plate 10 to fit and attach securely to A-pillar hinge housing 20, as well as with the A-pillar of the vehicle to which the hinge is attached.

Preferably, the parts of vehicle hinge 5 may connect to the vehicle door, the vehicle A-pillar and each other using such means as bolts or welding, but they may be connected using any means, including, but not limited to, nails, screws, friction, straps, zip-ties, chains, clips, binders, bungees, cords, ropes, strings, cables, fasteners, staples, hook and loop, bands, latches, stitches, snaps, wenches, glue, other natural or synthetic chemical adhesives, adhesive tape, heat bonding, chemical bonding, crimps, clamps, or ultrasonic welding.

Preferably, the parts of vehicle hinge 5 are made of metal alloy, but they can be made from any natural or synthetic material, including, but not limited to: metal; metal alloy; wood or other fibrous plant products; glass; composite materials such as graphite, fiberglass, boron, or Kevlar; admixtures of plastic resins combined with metal, metal alloy, wood or other fibrous plant product, glass, or composite materials; plastic; animal materials; or any combination of these materials, without departing from the scope of the present invention. In the best mode of the invention, vehicle hinge 5 will be made of materials that will support the weight of a vehicle door.

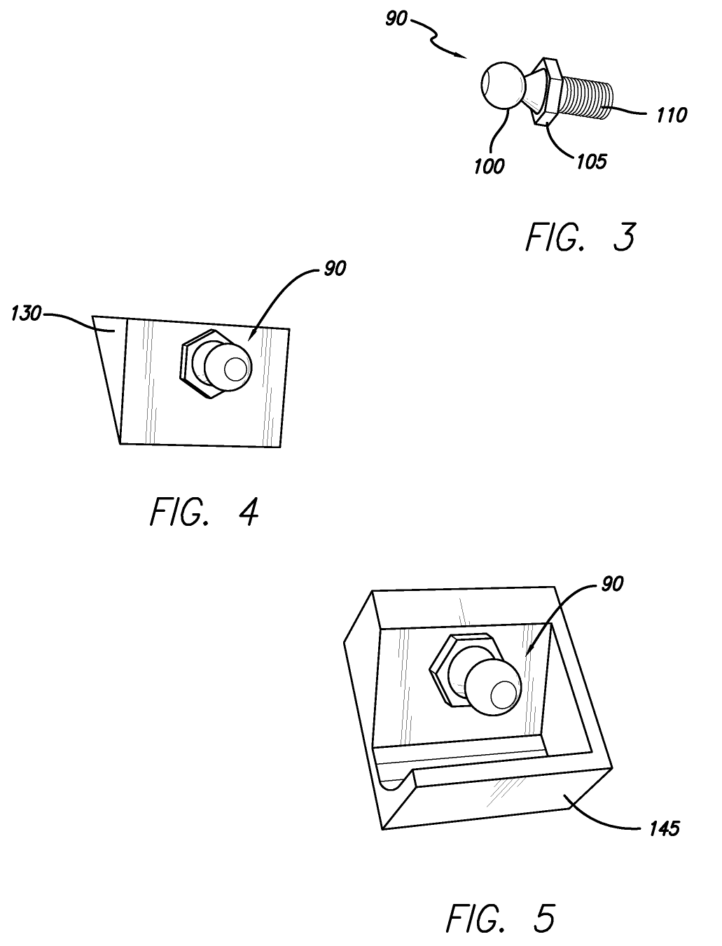

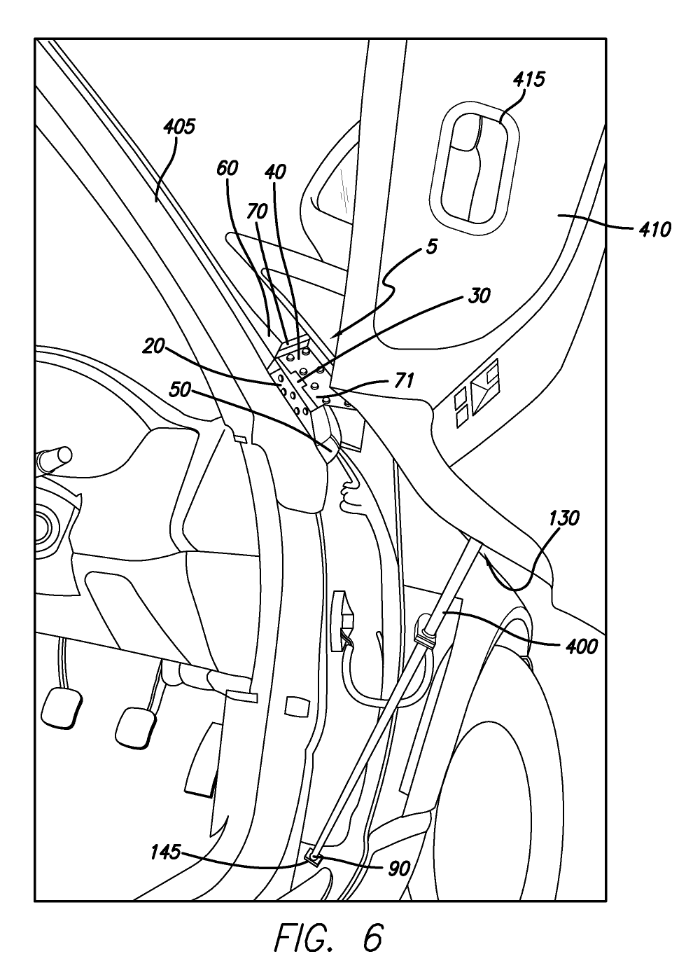

FIG. 3 is an illustration of a perspective view of one embodiment of a ball joint. The vehicle hinge of the present invention, preferably, includes: a lift support (not shown in FIG. 3) that supports the vehicle door as it opens and closes; a door angle mount (as shown in FIG. 4); and a chassis angle mount (as shown in FIG. 5). FIG. 3 shows a preferred embodiment of the ends of the lift support with ball joint 90, which has a ball 100, flush mount 105, and a connector pin 110. As shown in FIG. 3, flush mount 105 is preferably a hex and connector pin 110 is threaded.

FIG. 4 is an illustration of a perspective view of one embodiment of a door angle mount for a ball joint. As shown in FIG. 4, ball joint 90 is inserted, using the threaded connector pin 110, into door angle mount 130. Door angle mount 130 is attached to a front side of a vehicle door and ball joint 90 sticks out distally from the vehicle door. Door angle mount 130 is preferably angled to such a degree that the lift support is not subject to stresses that could bend or break the lift support.

FIG. 5 is an illustration of a perspective view of one embodiment of a chassis angle mount for a ball joint. As shown in FIG. 5, ball joint 90 is inserted into chassis angle mount 145. Chassis angle mount 145 is attached to the vehicle chassis, below the A-pillar, and ball joint 90 sticks out distally from the vehicle chassis. Chassis angle mount 145 is preferably angled to such a degree that the lift support is not subject to stresses that could bend or break the lift support. The lift support, when attached to both the chassis angle mount 145 and the door angle mount 130, provides easier manual operation or automatic opening and closing of the vehicle door, depending on the type of lift support used.

FIG. 6 is an illustration of an inside view of a vehicle with one embodiment of the vehicle hinge that is in an open position. As shown in FIG. 6, vehicle hinge 5 is open and attached to a vehicle and vehicle door 410. As preferred, FIG. 6 shows lift support 400 with a ball joint 90, and attached to chassis angle mount 145. Although not clearly shown in FIG. 6, lift support 400 is also attached to door angle mount 130, which is mounted on the side of door 410.

As shown in FIG. 6, vehicle door hinge 5 is preferably connected to the vehicle at the base of A-pillar 405. Aerodynamic structures 50 and 60 are shown providing the streamlined look and aerodynamic properties that are preferred in a visible, but camouflaged, hinge of the present invention. FIG. 6 shows A-pillar hinge housing 20 connected to A-pillar 405. Preferably A-pillar hinge housing 20 is connected to A-pillar 405 through a mounting base plate (not shown in FIG. 6). The top side of A-Pillar hinge housing 20, as shown in FIG. 6 in the preferred embodiment has flush fastener or threaded holes to allow easier bolt or screw connection to A-pillar 405. If A-pillar hinge housing is connected to a mounting base plate, the mounting base plate preferably has threaded receiving holes.

FIG. 6 also shows A-pillar hinge housing knuckle 30 connected to top leaf hinge knuckle 71 of hinge top leaf 70. Hinge top leaf 70 is mounted onto door reinforcement plate 40, as shown in FIG. 6, through flush fastener and treaded holes. Preferably door reinforcement plate 40 has flush fastener holes and hinge top leaf 70 has threaded receiving holes.

To close or open vehicle door 410, the standard door latch mechanism 415 is used to release or secure the door to the chassis. Although not shown, a supplemental latch may be installed to overcome deficiencies of the original manufacture door latch mechanism.

FIG. 7 is an illustration of an outside view of one embodiment of the vehicle hinge that is in an open position and attached to a vehicle and vehicle door. As shown in FIG. 7, vehicle hinge 5 preferably mounts to the base of A-pillar 405 and the top front portion of vehicle door 410. Typically, vehicle hinge 5 is painted the same color as the vehicle and is camouflaged as much as possible so not to be a distraction to a viewer of the car. FIG. 7 shows how vehicle hinge 5 is preferably a compact, yet robust hinge whose pivot axis 500 sits well above vehicle door 410. This allows vehicle door 410 to open or close without the skin of vehicle door 410 and the skin of vehicle fender 555 rubbing, scraping, or touching.

FIG. 7 shows how door reinforcement plate 40 attaches to vehicle door 410. Preferably door reinforcement plate 40 is attached to a reinforcement structure, such as a side impact beam of vehicle door 410. FIG. 7 also shows that mirror mount 525 and mirror 505 may be mounted on reinforcement plate 40. FIG. 7 also shows door reinforcement plate 40 attached to the bottom of hinge top leaf 70, and hinge top leaf 70 connected to A-pillar hinge housing 20. Aerodynamic structures 50 and 60, as shown and preferred, bookend hinge housing 20 to integrate vehicle hinge 5 into A-pillar 405 in an aerodynamic manner. Thus, vehicle hinge 5 is blended into A-pillar 405 in both a camouflaged and streamlined manner.

Finally, FIG. 7 shows lift support 400. Although not shown in FIG. 7, lift support 400 preferably connects to the end joints, then to an angle mount and then to the vehicle chassis and then to vehicle door 410.

In summary, the present invention is a vehicle door hinge that combines: aerodynamic features; a pleasing aesthetic shape; a hinge axis between the door and the A-pillar of the vehicle; an inexpensive price; off-the-shelf availability; and an ability to open a door simultaneously outward and upward.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A vehicle door hinge, comprising:
an A-pillar hinge housing;
a hinge pin;
a hinge top leaf; and
a door reinforcement plate;
wherein said A-pillar hinge housing is attached to an A-pillar of a vehicle;
wherein said door reinforcement plate is attached to a vehicle door;
wherein said hinge top leaf comprises a top leaf body and one or more top leaf hinge knuckles;
wherein said A-pillar hinge housing comprises an A-pillar hinge body and one or more A-pillar hinge housing knuckles;
wherein said hinge pin connects said one or more A-pillar hinge housing knuckles and said one or more top leaf hinge knuckles at a hinge pivot axis;
wherein said A-pillar hinge housing is attached to said mounting base plate; and
wherein said hinge top leaf is attached to said door reinforcement plate.

2. The vehicle door hinge of claim 1, further comprises:
a mounting base plate;
wherein said mounting base plate is attached to said A-pillar of said vehicle and said A-pillar hinge housing; and
wherein said mounting base plate is between said A-pillar of said vehicle and said A-pillar hinge housing.

3. The vehicle door hinge of claim 2, wherein said hinge pivot axis is positioned just above a top side of a vehicle door and so that when said vehicle door is opened a door skin clears a fender skin without touching or scraping; and
wherein said mounting base plate is attached at a forward base of said A-pillar of said vehicle; and
wherein said reinforcement plate is attached to a reinforcement structure of said vehicle door.

4. The vehicle door hinge of claim 3, further comprising:
a lift support;
a chassis angle mount; and
a door angle mount;
wherein said chassis angle mount is mounted to a chassis of said vehicle;
wherein said door angle mount is mounted to said vehicle door;
wherein said lift support comprises a chassis end and a door end;
wherein said lift support chassis end connects to said chassis angle mount and said lift support door end connects to said door angle mount; and
wherein said lift support provides support in lifting said vehicle door when opening or closing said vehicle door.

5. The vehicle door hinge of claim 4, wherein said door reinforcement structure is a side impact beam of said vehicle door.

6. The vehicle door hinge of claim 5, wherein said A-pillar of said vehicle is a roll over reinforcement structure of said vehicle.

7. The vehicle door hinge of claim 6, further comprising:
an one or more aerodynamic structures that assist in blending the shape of the hinge top leaf into the shape of said A-pillar of said vehicle;
wherein said hinge top leaf has an aerodynamic shape that reduces wind resistance and noise.

8. The vehicle door hinge of claim 7, further comprising:
an one or more washers;
wherein said one or more washers are placed between said one or more A-pillar hinge housing knuckles and said one or more top leaf hinge knuckles such that a precise paint gap is maintained.

9. The vehicle door hinge of claim 8, wherein said one or more A-pillar hinge housing knuckles have threaded end caps that secure said hinge pin.

10. The vehicle door hinge of claim 9, wherein said mounting base plate has an one or more chamfered surfaces that facilitate attachment to said A-pillar of said vehicle.

11. The vehicle door hinge of claim 10, wherein said mounting base plate further comprises threaded holes that facilitate attachment to said A-pillar hinge housing.

12. A vehicle door hinge, comprising:
a mounting base plate;
an A-pillar hinge housing;
a hinge pin;
a hinge top leaf; and
a door reinforcement plate;
wherein said mounting base plate is attached to a base of an A-pillar of a vehicle;
wherein said door reinforcement plate is attached to a vehicle door reinforcement structure;
wherein said hinge top leaf comprises a top leaf body and one or more top leaf hinge knuckles;
wherein said A-pillar hinge housing comprises an A-pillar hinge body and one or more A-pillar hinge housing knuckles;
wherein said hinge pin connects said one or more A-pillar hinge housing knuckles and said one or more top leaf hinge knuckles at a hinge pivot axis;
wherein said A-pillar hinge housing is attached to said mounting base plate;
wherein said hinge top leaf is attached to said door reinforcement plate;
wherein said door reinforcement structure is a side impact beam of said vehicle door; and
wherein said A-pillar of said vehicle is a roll over reinforcement structure of said vehicle.

13. The vehicle door hinge of claim 12, further comprising:
a lift support;
a chassis angle mount; and
a door angle mount;
wherein said chassis angle mount is mounted to a chassis of said vehicle;
wherein said door angle mount is mounted to said vehicle door;
wherein said lift support comprises a chassis end and a door end;
wherein said lift support chassis end connects to said chassis angle mount and said lift support door end connects to said door angle mount; and
wherein said lift support provides support in lifting said vehicle door when opening or closing said vehicle door.

14. The vehicle door hinge of claim 13, wherein said hinge pivot axis is positioned just above a vehicle door so that when said vehicle door is opened a door skin clears a fender skin.

15. The vehicle door hinge of claim 14, further comprising:
an one or more washers;
wherein said one or more washers are placed between said one or more A-pillar hinge housing knuckles and said one or more top leaf hinge knuckles such that a precise paint gap is maintained.

16. The vehicle door hinge of claim 15, further comprising:
an one or more aerodynamic structures that assist in blending the shape of the hinge top leaf into the shape of said A-pillar of said vehicle;
wherein said hinge top leaf has an aerodynamic shape that reduces wind resistance and noise.

17. The vehicle door hinge of claim 16, wherein said one or more A-pillar hinge housing knuckles have threaded end caps that secure said hinge pin.

18. The vehicle door hinge of claim 17, wherein said mounting base plate has an one or more chamfered surfaces that facilitate attachment to said A-pillar of said vehicle.

19. The vehicle door hinge of claim 18, wherein said mounting base plate further comprises threaded holes that facilitate attachment to said A-pillar hinge housing.
